(19) United States
(12) Patent Application Publication
(10) Pub. No.: US 2008/0212067 A1
(43) Pub. Date: Sep. 4, 2008

(54) INSPECTION AND STRENGTH MEASUREMENT OF SOLDER AND STRUCTURAL JOINTS USING LASER GENERATED STRESS WAVES

(75) Inventor: Vijay Gupta, Sherman Oaks, CA (US)

Correspondence Address: JOHN P. O'BANION;O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA, Oakland, CA (US)

(21) Appl. No.: 11/840,090

(22) Filed: Aug. 16, 2007

Related U.S. Application Data
(63) Continuation-in-part of application No. PCT/US2006/005896, filed on Feb. 17, 2006.
(60) Provisional application No. 60/654,187, filed on Feb. 17, 2005.

(51) Int. Cl. G01L 1/24

(52) U.S. Cl. 356/35.5

(57) ABSTRACT

Methods and apparatus are disclosed for direct measurement of the tensile strength of joints with use of laser spallation. A laser pulse is directed at a surface in communication with a solder joint, generating a stress wave to separate the solder ball from its underlying structure. The solder joint may be measured either prior to joining of a PCB board or CSP package, or after they have been joined. The joints for testing may be prepared by polishing either the PC board or the CSP package to expose the desired solder joint for testing. The tensile strength of the embedded joints may also be measured in-situ.

### CROSS-REFERENCE TO RELATED APPLICATIONS

This application claims priority from, and is a 35 U.S.C. §111(a) continuation-in-part of, co-pending PCT international application serial number PCT/US2006/005896, filed on Feb. 17, 2006, incorporated herein by reference in its entirety, which claims priority from U.S. provisional application Ser. No. 60/654,187 filed on Feb. 17, 2005, incorporated herein by reference in its entirety.

This application is related to PCT International Publication Number WO/2006/089257, published on Aug. 24, 2006, incorporated herein by reference in its entirety.

### STATEMENT REGARDING FEDERALLY SPONSORED RESEARCH OR DEVELOPMENT

This invention was made with Government support under Grant No. DMI-0323804, awarded by the National Science Foundation and Grant No. DAAD19-00-1-0491, awarded by the Army Research Office (ARO). The Government has certain rights in this invention.

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to measuring tensile strength of joints, and more particularly to measuring tensile strength of solder joints via laser spallation.

2. Description of Related Art

Ball grid array (BGA) packaging of integrated circuits is an important technology that utilizes solder balls as the interconnect to the board, instead of the leads used by peripheral array surface mount package types. The use of solder balls allows higher pin counts, and offers other advantages such as robust processing, enabled by their higher pitch, better lead rigidity, and self-alignment characteristics during the reflow process. It is the technology of choice for chip-scale packages (CSPs) and in flip chip packages.

It is well known that the formation of intermetallic compounds (IMC) helps maintain a good bonding between the solder and the underlying package substrate and printed circuit board (PCB) metallic pads. However, under high temperature environments, IMC growth can become excessive. This results in brittle interfaces and deteriorates the mechanical integrity of the solder joint. This problem is also compounded by further changes in the morphology of the IMCs and formation of interfacial voids during thermal aging. Thus, in-situ measurement and maximization of the solder joint adhesion, and predicting its degradation by directly relating the joint strengths to the evolution and stability of the IMCs under high temperature processing and service conditions, becomes very important to understand from the standpoint of reliability.

Therefore, an object of the present invention is an adhesion metrology tool for assessing the strength of solder joints.

### BRIEF SUMMARY OF THE INVENTION

An aspect of the invention is a method for measuring the tensile strength of a solder joint disposed between a solder ball and an underlying structure. The method includes the steps of directing a laser pulse at a first surface in communication with the solder joint, and generating a stress wave in the solder joint as a result of the laser pulse. The stress wave propagates from the first surface to the solder joint to generate a tensile stress in the solder joint. Preferably, the tensile stress is configured to separate the solder ball from the underlying structure.

In a preferred embodiment, the laser pulse is directed at an exposed surface of the solder ball, such that the stress wave propagates through the solder ball and into the solder joint. The solder ball is typically coupled to underlying structure via a metal pad, and the tensile stress separates the solder ball from the metallic pad.

The underlying structure may comprise a single layer of material, or multiple layers of materials such as die paste, silicon, and/or mold compound.

In another embodiment, the strength of the solder joint is measured by determining a critical laser energy sufficient to cause the solder ball to separate from the underlying structure, and calculating the strength of the solder joint as a function of the value of said critical laser energy.

In yet another embodiment, the strength of the solder joint is measured by directing an interferometer at a second surface opposite the first surface, and measuring the free velocity of the second surface that results due to the stress wave caused by the interaction of the laser pulse with the first surface. A stress wave profile may then be generated from the measured free velocity. The stress wave profile is then further used to identify the peak tensile stress amplitude at a location in the solder joint, wherein the peak tensile stress corresponds to the strength of the joint.

In some embodiments, the second surface may be polished to expose the solder joint, with the interferometer directed at said polished free surface.

The solder joint may comprise a number of configurations. For example, the solder joint may be an interface between a silicon die and a plastic substrate in a flip chip circuit. In such a case, the laser pulse may be configured to be directed to measure the tensile strength either between the silicon die and the solder ball, or between the plastic substrate and the solder ball. The laser pulse may also be directed at a free surface of the plastic substrate or silicon die to measure the tensile strength of the solder joint in situ.

The solder joint may also comprise an interface between a PCB and a substrate in a CSP package. In this case, the laser pulse may be configured to be directed to measure the tensile strength either between the PCB die and the solder ball, or between the plastic substrate and the solder ball. In this case, a region around the solder ball may be filled with a propagation medium, such that a laser pulse directed at a free surface of the PCB propagates to the solder ball to measure the tensile strength of the solder joint in situ.

In an alternative embodiment, the first surface may be a free surface of the underlying structure, such that the stress wave propagates through the underlying structure and into the solder joint. If necessary, a metal film may be deposited adjacent the first surface. The laser pulse impinges on the metal film to generate melting-induced expansion of the metal film to impart the stress wave in the underlying structure.

Another aspect of the invention is an apparatus for measuring the tensile strength of a solder joint disposed between a solder ball and an underlying structure. The apparatus includes a laser source configured to be directed at a first surface in communication with the solder joint to generate a stress wave that propagates from the first surface to the solder joint to generate a tensile stress in the solder joint. The laser source preferably comprises a Nd-Yag laser, but may be any laser known in the art.

The apparatus may also include processing electronics and software configured to determine a critical laser energy sufficient to cause the solder ball to separate from the underlying structure, and calculate the strength of the solder joint as a function of the value of said critical laser energy.

In another embodiment, the apparatus further includes an interferometer configured to be directed at a second surface opposite said first surface to measure the free velocity of the second surface. The processing electronics and software may also be configured to generate a stress wave profile from the measured free velocity, to calculate the peak tensile stress amplitude at a location in the solder joint, wherein the peak tensile stress corresponds to the to the joint strength. The laser source may be configured to be directed at an exposed surface of the solder ball to propagate the stress wave through the solder ball and into the solder joint, or at a free surface of underlying structure to propagate the stress wave through the underlying structure and into the solder joint.

In a further aspect, a method is disclosed for generating a stress wave in a solder joint by directing a laser pulse at a first surface in communication with the solder joint, generating a stress wave in the solder joint as a result of the laser pulse, and propagating the stress wave from the first surface to the solder joint to generate a tensile stress in the solder joint. The magnitude of the stress wave may be controlled to result in separation of the solder ball from the underlying structure.

In other embodiments, joints containing joint materials other than solder balls can be used with the techniques of the present invention, such as adhesives, other chemical materials, or mechanical materials.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic diagram of a laser spallation tensile strength measuring system using a laser Doppler displacement interferometer.

FIG. 2 illustrates an expanded view of a cross-section of a prior art thin film sample assembly.

FIG. 3 illustrates a schematic diagram of a CSP incorporating flip chip circuitry.

FIG. 4 is a schematic diagram of a CSP integrated with a printed circuit board.

FIG. 5 shows a close up view of a solder ball interface of the CSP of FIG. 4.

FIG. 6 shows a top view of a solder ball and underlying structure.

FIG. 7 illustrates cross-sectional view of a system of the present invention for measuring the strength of a solder joint specimen of FIG. 6.

FIG. 8 is another cross-sectional view of the solder joint specimen of FIG. 6 in accordance with the present invention.

FIG. 9 illustrates a diagram of a test specimen comprising an array of solder balls coupled to metal pads disposed on a mold compound.

FIG. 10 illustrates a series of microscopic views of solder joint fracture surfaces of the array of FIG. 9 induced by the laser spallation technique of the present invention.

FIG. 11 shows a schematic diagram of a test setup in accordance with the present invention for measuring the free surface velocity of the underlying structure of the test sample using an interferometer.

FIG. 12 shows exemplary stress wave analysis results at the solder joint, in which the final tensile stress histories generated at the solder joint were calculated for an underlying structure comprising only a thick mold compound layer.

FIG. 13 shows exemplary stress wave analysis results for an underlying structure comprising multiple layers of die paste, Si die, and mold compound.

FIG. 14, shows a schematic diagram of an alternative test setup in accordance with the present invention wherein a YAG laser beam is focused on the free surface of the underlying structure.

FIG. 15 illustrates an alternative test setup wherein the solder balls are absent or polished to measure the surface velocity of the free surface.

FIG. 16 shows exemplary finite element analysis wave propagation model in accordance with the present invention.

FIG. 17 shows results of the finite element analysis simulation using the model of FIG. 16, showing the peak interfacial stress over time,

FIG. 18 shows results of the finite element analysis simulation using the model of FIG. 16, showing the peak interfacial stress at varying laser energies.

FIG. 19 is a schematic diagram of an alternative test setup for measuring the tensile strengths of embedded solder joints in-situ by directing a laser pulse at the back surface of a device.

FIG. 20 is an alternative in-situ measurement setup wherein the laser pulse is directed at the die or CSP package surface.

FIG. 21 illustrates an alternative in-situ measurement setup with a polished surface.

### DETAILED DESCRIPTION OF THE INVENTION

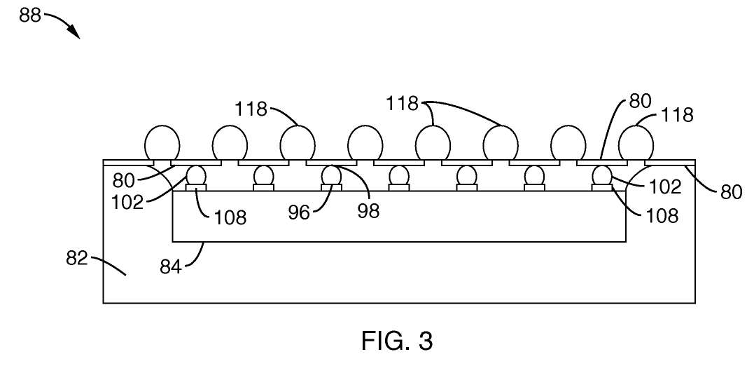

Referring more specifically to the drawings, for illustrative purposes the present invention is embodied in the apparatus generally shown in FIG. 3 through FIG. 21. It will be appreciated that the apparatus may vary as to configuration and as to details of the parts, and that the method may vary as to the specific steps and sequence, without departing from the basic concepts as disclosed herein.

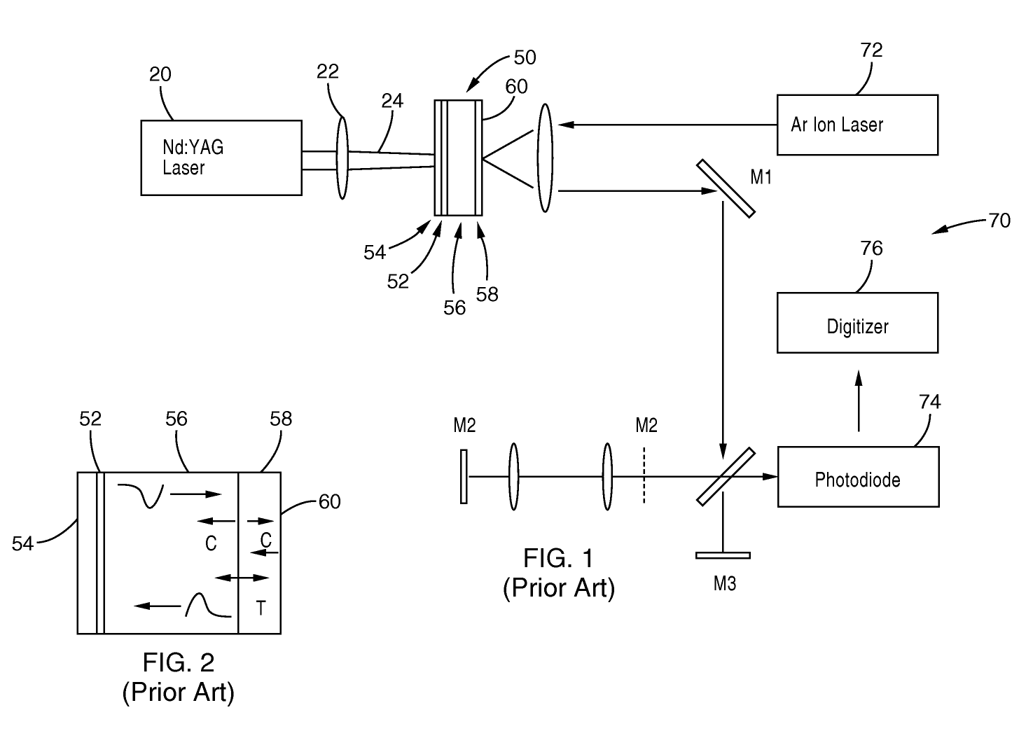

FIG. 1 illustrates a setup using laser spallation techniques, which are described in more detail in U.S. Pat. No. 5,438,402, incorporated herein by reference in its entirety. A 3-nanoseconds (ns) long Nd:YAG laser pulse is directed at sample assembly 50 and made to impinge over a 3 mm-diameter area on a 0.5 μm thick aluminum film 52 that is sandwiched between the back surface of a substrate disc (having a 12-25 mm diameter and 1-mm thickness) and a 10 to 20 μm thick layer of SiO₂.

When actuated, the first input laser 20 generates a laser pulse that passes along the first axis to the lens 22. The lens 22 collimates the laser pulse into a collimated beam 24 that is incident upon a constraining layer 54.

The constraining material 54 is generally partially transparent to the input laser pulse, thereby transferring the pulse to the energy absorbing aluminum layer 52. Absorption of the laser pulse by the energy absorbing layer 52 leads to a sudden melting-induced expansion of the aluminum layer 52 which, due to the axial constraints of the assembly, e.g., the constraining material 54 and the substrate 56, generates a compressive shock wave or stress pulse directed towards the substrate 56 and the test coating 58, which is deposited on the substrate 56 front surface.

As illustrated in FIG. 2, the compressive stress pulse propagating through the substrate 56 is incident upon the interface between the substrate 56 and the test coating or sample 58. A part of the compressive pulse is transmitted into the coating as the compression pulse strikes the interface. The compressive pulse reaches the coating free surface 60 where it is reflected, thereby forming a tension pulse T. The interface tensile stress is obtained by measuring the transient displacement history of the coating's free surface 60 (induced during pulse reflection) by using an optical interferometer 70, a schematic of which is shown FIG. 1. It is this formation of the tension pulse T that leads to the removal of the coating 58 from the substrate/coating interface, given a sufficiently high amplitude.

When the stress pulse is reflected from the free surface 60 of the coating 58 (or any thick material plate) or the substrate 56, the particles at the free surface experience a transient velocity, which is proportional to the transient profile of the striking stress pulse. This transient velocity is measured directly by the laser Doppler interferometer system 70 of FIG. 1. Doppler interferometer system 70 comprises a second input (Ar Ion) laser 72, a series of collimating lenses, mirrors M1-M3, and a photodiode 74 and digitizer 76.

For a coating of density ρ and thickness h, the interface stress δ is calculated from the measured transient velocity v(t) as:

δ(h,t)=½ρc[v(t+h/c)−v(t−h/c)]

where c is the longitudinal stress wave velocity in the film.

FIG. 3 illustrates a CSP 88 incorporating flip chip circuitry commonly used in the art. In flip chip packages, a series of individual solder balls 102 communicate between a silicon die 84 and a plastic substrate 80. Thus, the solder ball 102 makes two joints, the first (die side) joint 96 comprising the contact point between the solder ball 102 and the die 84, and the second (substrate side) 98 between the solder ball 102 and the substrate 80. In both joints, the solder ball 102 makes contact through a metal (intermediate) pad 108 (e.g., copper or Ni-coated copper) to communicate with the underlying electronics. During heat treatment or reflow, the two solder joints undergo changes in their chemistry in the very close vicinity of the respective metal pads. These chemical changes manifest themselves in the form of strength-degrading intermetallic compounds or formation of voids or both.

It is of interest to determine the strength of both of these solder joints prior to joining and after reflow. The present invention allows direct measurement of the tensile strength of each of these solder joints individually, either prior to joining of the plastic substrate and the die, or after they have been joined, in which case the joints for testing are prepared by polishing either the substrate or the die to expose the desired solder joint for testing. Alternatively, the invention also allows measuring the in-situ tensile strength of the embedded solder joints in which case there is no need to polish off the substrate or the die to expose the joint to be tested, as testing can be done in-situ with the substrate and the die sandwiching the two joints.

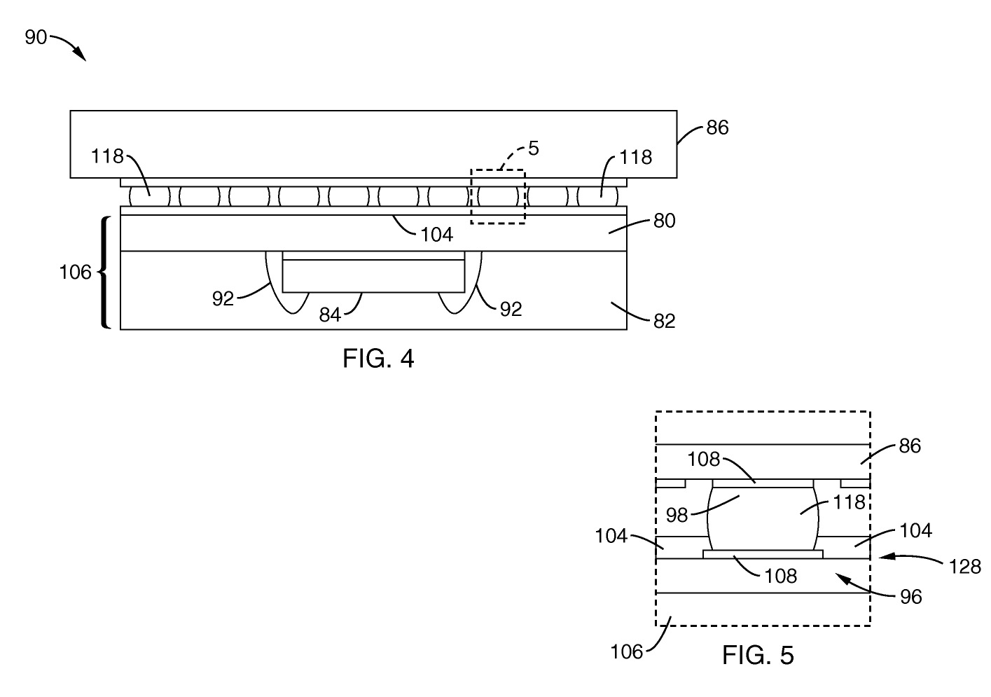

FIGS. 4 and 5 illustrate an exemplary CSP 90 (e.g. wire bond thin and fine pitch ball grid array (TPGA)) integrated with a printed circuit board 86 (PCB). Similar to the flip chip case, the solder ball 118 in chip scale packages sits on top of a metal pad 108 (e.g., copper pad or nickel coated copper). These chip scale packages are eventually mounted to a board 86 (as shown in FIGS. 4 and 5, where the solder ball 118 connects to yet another metal pad 108 on the board side to make the second joint 98 as in the flip-chip case. Heat treatment and reflow during board mounting raises the temperature of the solder, which in turn leads to formation of strength-degrading intermetallic compounds, voids, or both. It is of interest to determine the strength of both of these solder joints 96, 98 prior to joining and after reflow.

The present invention allows direct measurement of the tensile strength of each of these solder joints individually, either prior to joining of the board 86 or the CSP package 90, or after they have been joined, in which case the joints for testing are prepared by polishing either the PC board 86 or the CSP package 90 to expose the desired solder joint for testing. That is, the PC board 86 is polished off where the die-side solder joint 96 to the die (CSP package 90) is desired to be tested, and the die (CSP package 90) is polished off where the strength of the solder joint to the PC board is desired to be measured. In addition to above, the invention also allows measurement of the in-situ tensile strength of the embedded solder joints to obviate the need to polish off the board 86 or the CSP package 90 to expose the joint to be tested, as testing can be accomplished in-situ with the board and the die sandwiching the two joints.

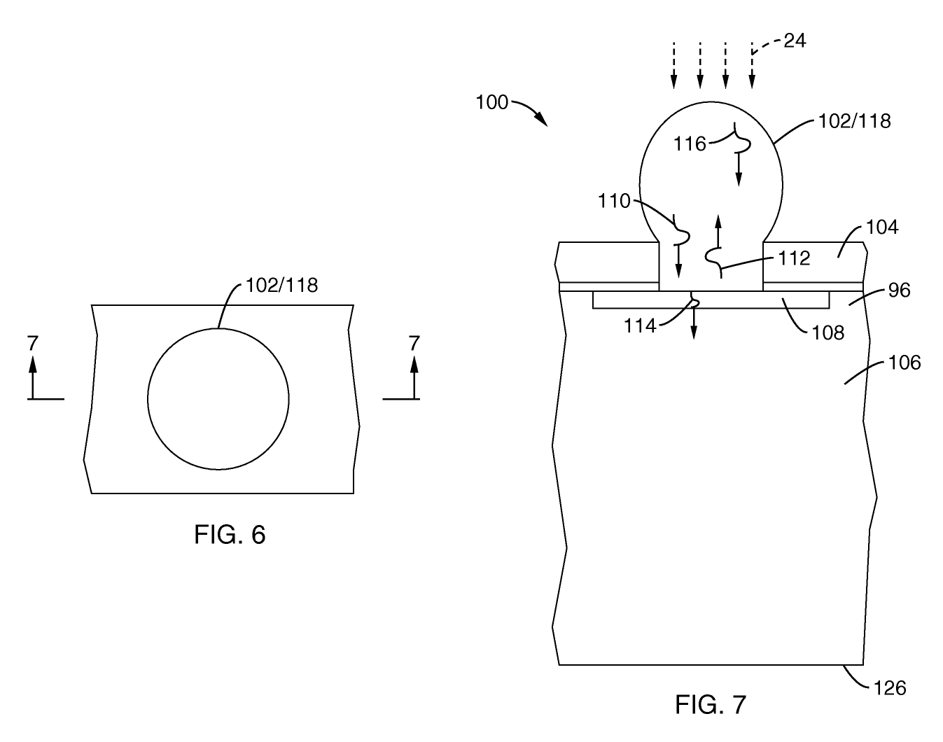

FIGS. 6 and 7 illustrate an embodiment of the present invention for measuring a solder joint specimen 100. First, specimen 100 is aligned with a YAG laser beam 24, similar to the test setup shown in FIG. 1 (wherein specimen 100 is used in place of the sample assembly 50). The tensile strength of the joint 96 formed between an individual solder ball 102/118 and the metal pad 108 may be measured irrespective of the underlying structure 106 that supports the metal pad 108. For example, the underlying structure 106 may be a die, substrate, PC board, or the like. Accordingly, the solder joint 96 may be produced on a die-pad, substrate-pad or a board-pad prior to any joining to other electronic components. Alternatively, the joint could be prepared for testing by polishing one or several of the electronic components to expose the joint.

In the embodiment shown in FIG. 7, the solder ball 102/118 interfaces with the metal pad 108 through a solder mask or tape 104 (e.g. polyimide). The pad 108 could be of any metal (e.g. Cu), or layers of different metals. In addition, for thermally aged samples, the metal pad 108 could be transformed into multiple layers of intermetallic compounds.

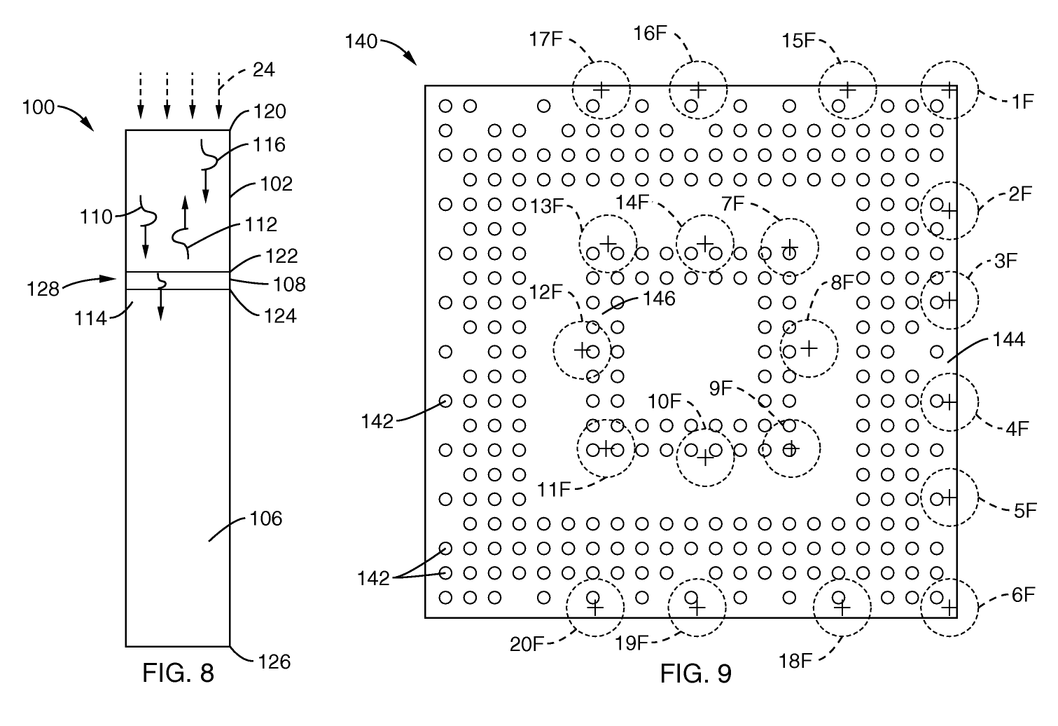

As in the basic laser spallation method shown in U.S. Pat. No. 5,438,402, incorporated herein by reference in its entirety, a laser pulse 24 from a YAG laser 20 is focused directly on top of the solder ball 102/118. The area of beam focus 24 may be varied to include just one solder ball, or several balls simultaneously. The solder material absorbs the laser pulse, thereby launching a pressure (compression) wave 110 is launched inside the solder ball. The pressure wave 110 then propagates from the free surface 120 (see also FIG. 8, which shows an axial section through the center of the specimen 100) towards the solder joint 128 defined by surface 122 at its upper extremity, and surface 124 at its lower extremity. The solder joint 128 may comprise several intermetallic compounds with or without voids formed upon thermal aging.

Part of the incoming pressure wave 110 reflects back as compression wave 112, towards the free surface 120 of the solder ball after impinging the solder joint 128. The reflected wave 112 is also a compression wave. This reflected pressure (compression) wave, upon reaching the free surface 120 of the solder ball is reflected once again and travels back towards the solder joint 128 as stress wave 116. However, because 120 is a free surface, the reflected wave 116 changes sign and becomes tensile. The tensile wave 116 then loads the joint 128 in tension, and if the amplitude of the wave is high enough, the solder joint 128 is completely pulled apart, as indicated by a complete dislodging of the solder ball 102/118 from the joint 128. By repeating this process, the critical laser energy is found (e.g. point at which the solder ball 102/118 is just removed from its joint 128).

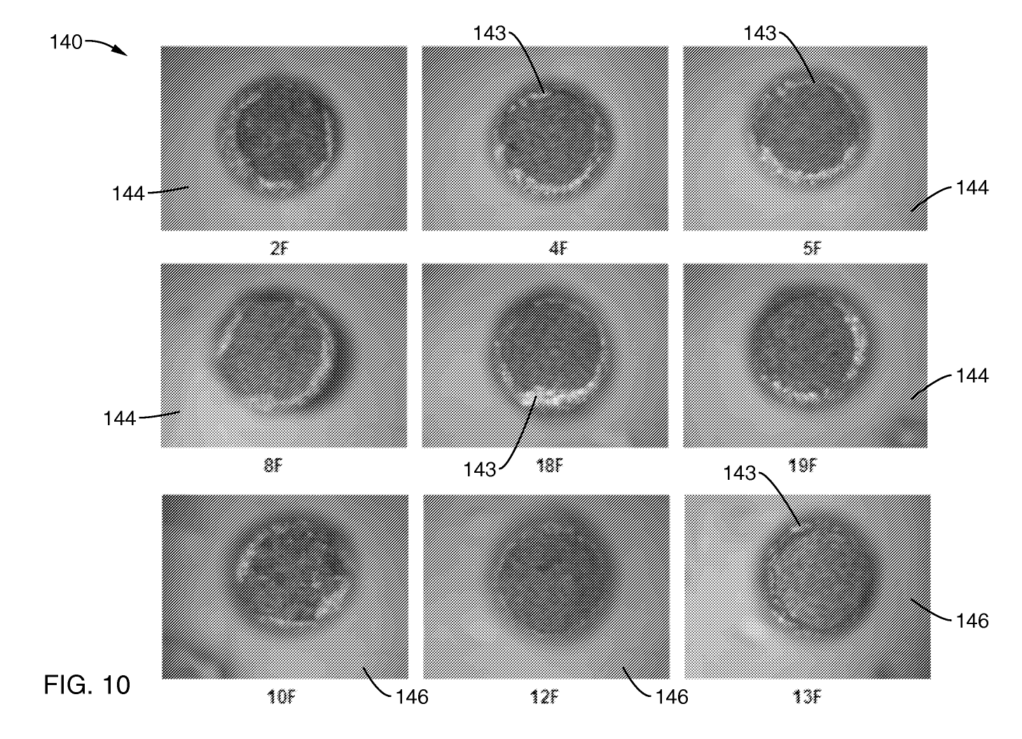

Referring now to FIGS. 9-10, an experiment was performed in which laser-generated stress waves were induced on a solder ball that was attached a metal pad, with varying underlying structures 106 beneath the pad.

In some embodiments, the solder joints may be tested in terms of critical laser energies only, without quantifying the amplitude of the stress wave that eventually accomplishes the joint failure. Even without knowing the actual stress, the laser energies can be used as a relative measure of the joint strength when comparing different thermal aging conditions, or different metal pads.

FIG. 9 illustrates a diagram of a test specimen 140 comprising an array of solder balls 142 coupled to metal pads disposed on a mold compound. The locations of the solder balls (1F-20F) identified in FIG. 9 correspond to the data points (1F-20F) in Table 1, as well as each of the photos in FIG. 10

The outermost region 144 of the specimen (e.g., 1F, 2F, 3F, 4F, 5F, 6F, 15F, 16F, 17F, 18F, 19F, and 20F), shown in FIGS. 9 and 10 had only the mold compound (e.g. single layer) as the underlying layer. In contrast, the inner region 146 (7F-14F) further comprised an additional Si die (e.g. multiple layer). As shown in Table 1, the critical laser energy at which the solder ball was removed from the joint was found to be substantially the same and did not depend upon the location on the package where the tested solder balls were located. The failure mode, i.e. the location 143 (as shown in FIG. 10) where the solder ball 142 is separated in the joint, was also found to be relatively identical, even when the underlying structure 106 was changed.

The independence of the critical laser energy with respect to the location of the solder ball tested suggests that the joint is separated by the tensile wave 116 that is generated from the top free surface of the solder ball, rather than by the stress wave 114 going through the joint. However, it is appreciated that failure caused by the stress wave 114 is a possibility for certain class of BGA geometries and structures underneath them.

Unlike the previously disclosed laser spallation, there is no need to deposit a laser absorbing metal film on top of the solder balls. Similarly, there is no need for any confinement using the waterglass material. Sufficient stress pulse amplitudes can be generated without the use of these layers. However, a constraining layer and/or energy absorbing layer may be desirable for certain solder and pad materials, which may require higher stress wave amplitudes.

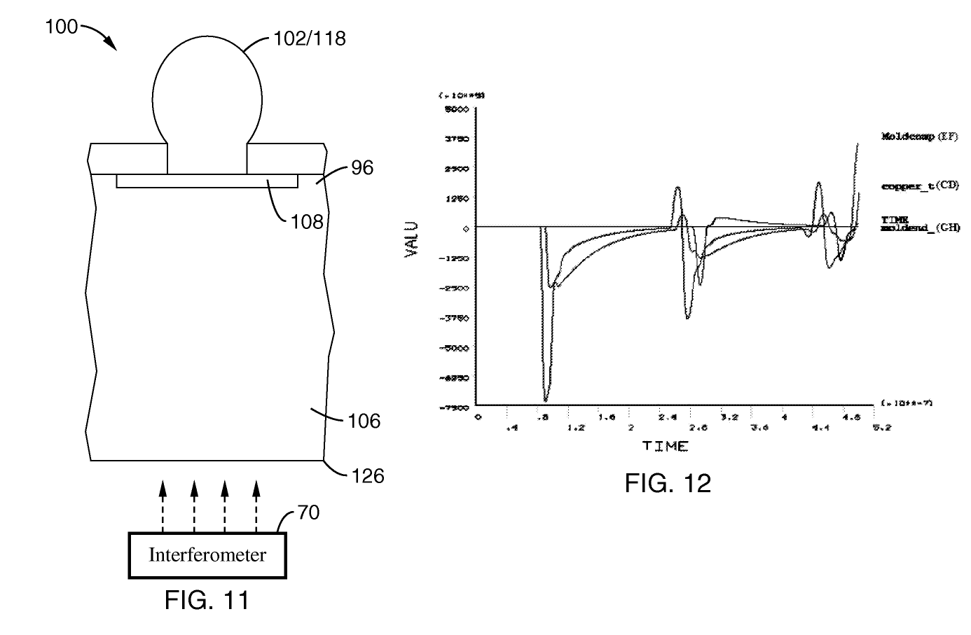

In an alternative embodiment, the quantitative values may be acquired by determining the tensile strength of the joint 128 by use of interferometry and a wave mechanics-based finite element simulation. In this embodiment, the stress wave profile generated inside the solder ball is quantified first. Referring to FIG. 11, the free surface velocity of the underlying structure 106 is measured using an interferometer 70 directed at surface 126. Depending upon the type of the underlying structure 106, it may be necessary to either polish the thickness of the material 106 metal pad 108 to a size that allows for a good interferometer signal, or to deposit a metal film (aluminum, for example) for better reflection of the interferometeric laser beam. The end result of this step is to record the velocity of the free surface 126.

With known or estimated elastic properties of the materials, e.g. the solder 102, metal pad 108, intermetallics, and underlying layers 106, the measured free surface velocity is converted to an equivalent stress wave profile (e.g. stress wave 110) generated inside the solder ball, by using well-known equations of wave mechanics. Next, the estimated stress wave profile in the solder is used in a wave mechanics-based finite element simulation (and/or an analytical model), to calculate the peak tensile stress amplitude anywhere in the solder joint 128. When carried out at the critical laser energy at which the solder balls are completely removed from the joint (as obtained from the embodiment shown in FIGS. 6-10), the final peak tensile stress in the region 128 will correspond to the joint strength.

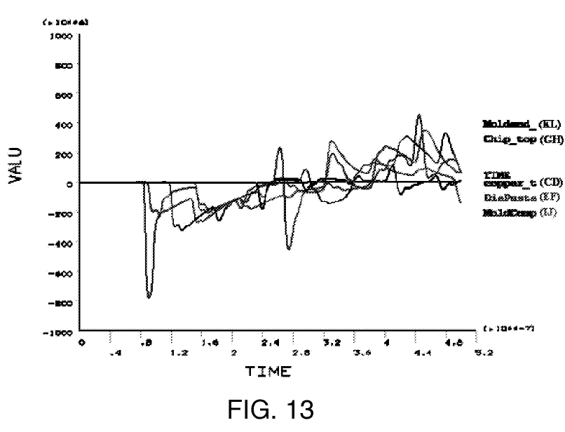

FIG. 12 shows exemplary stress wave analysis results at the solder joint 128, in which the final tensile stress histories generated at the solder joint 128 were calculated for the case where the underlying structure 106 is only a thick mold compound layer. FIG. 13 demonstrates another calculation in which the underlying structure 106 comprises multiple layers of die paste, Si die, and a mold compound.

The embodiment shown in FIG. 11 may be configured such that the user may record the critical laser energy for solder ball spallation and convert it into a joint strength value using a computer program. In this case, there would be no need for interferometry measurements. Thus, data obtained from embodiment shown in FIGS. 6-10 may be compared against a computerized chart to convert the laser energy into a joint strength value

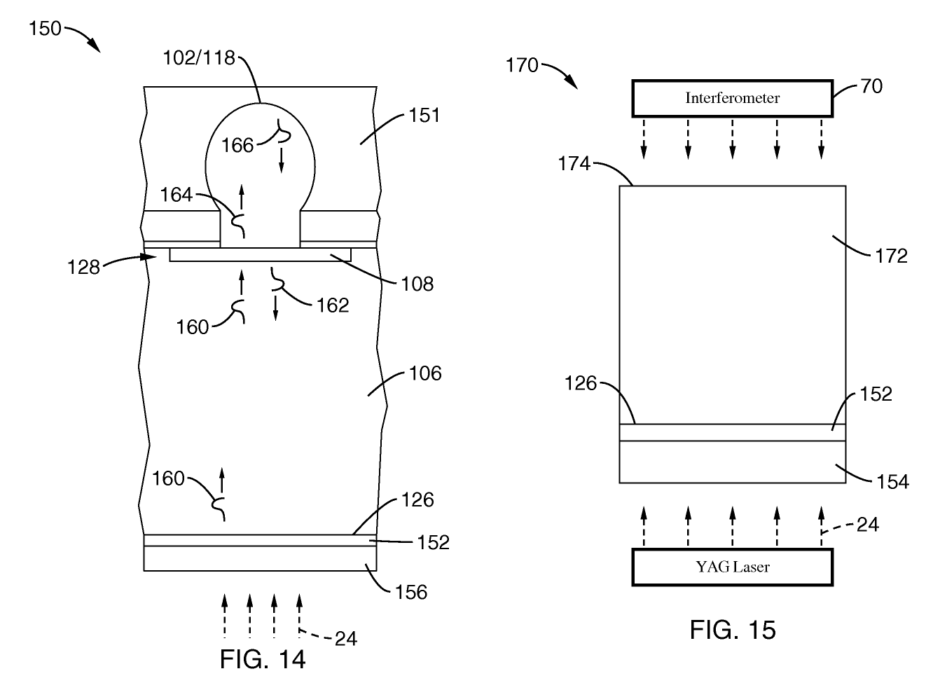

Referring now to FIG. 14, solder joint 128 may also be tested by focusing the YAG laser beam 126 on the free surface 126 of the underlying structure 106. As shown in FIG. 14, the solder ball 102/118 may be embedded in a layer of underfill material 151, e.g. in the case of a flip-chip package. The underlying structure 106 may comprise a mold compound, a plastic substrate, a silicon die with the die paste, or a combination of any other electronic components.

Depending upon the material system at hand, it may become necessary to enhance the interrogating stress wave amplitude by depositing a metal film 152 on the free surface 126 of the specimen 150. In this embodiment, the compression wave is generated by melting-induced expansion of the metal film 152 (e.g. Aluminum) under confinement from a waterglass layer 154. As indicated earlier, for some systems, it my not be necessary to put an Al film 152, and the natural structure of the underlying structure 106 may be used as the laser-absorbing material. Similarly, it may or may not be necessary to use the confining waterglass layer 154.

Referring to still to FIG. 14 the generated compression wave travels to the solder joint by traversing the materials of the underlying structure 106. Part of this compression wave 164 transmits through the solder joint 128 and is reflected into a tensile wave 166 from the free surface of the solder ball 102/118. The returning tensile wave 166 from the free surface of the solder ball pulls the joint 128 apart in tension. The joint 128 fails if the amplitude of the tensile wave is high enough, which in turn is directly controlled by the laser fluence deposited on the surface opposite to that carrying the solder balls (e.g. free surface 126).

In the embodiment shown in FIG. 14, solder joints may be tested in terms of critical laser energies only, without quantifying the amplitude of the stress wave that eventually accomplishes the joint failure. Even without knowing the actual stress, the laser energies can be used as a relative measure of the joint strength when comparing different thermal aging conditions, or different metal pads.

In yet another embodiment, the qualitative process shown in FIG. 14 is made quantitative by calculating the tensile strength of the solder joints by using interferometry and a wave mechanics-based simulation. In this embodiment, the stress wave generated in the lower electronic substrate (die, mold compound, plastic substrate, board or any other electronic component of combination thereof) making up the underlying structure 106 is determined in a separate experiment, as shown in FIG. 15.

The substrate 172 shown in FIG. 15 is absent the solder balls. Substrate 172 may be acquired as-is from commercially available sources, or may be fabricated by polishing off the solder balls and their supporting metal pads so as to leave the structure underneath the pad intact. The lower surface is then prepared to match the setup as shown in FIG. 11, i.e. metal layer 152 and the accompanying waterglass 154 are positioned adjacent surface 126, where appropriate. The same laser energy and laser focus area used in FIG. 14 to completely separate the solder ball at the joint is then directed at bottom surface 126 to generate the stress wave in the electronic substrate 172. This stress wave propagates away from the laser impingement area at surface 126 and travels through the substrate thickness to reach the second free surface 174 of the substrate that was created by polishing off of the solder balls. An optical interferometer 70 is then used to record the free surface velocity of the electronic substrate surface 174 that was generated by the reflecting stress wave.

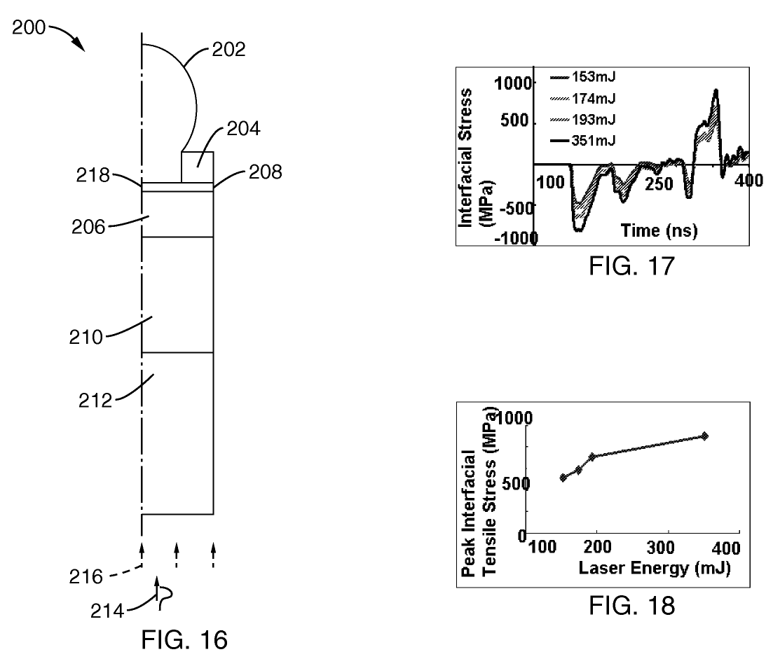

The experimentally measured stress wave profile derived from the electronic substrate shown in FIG. 15 is then used as an input to a wave propagation model. An exemplary finite element analysis wave propagation model 200 is illustrated schematically in FIG. 16. The FEM model 200 shown in FIG. 16 is configured to model the stress wave for a specific package geometry, having solder ball 202, polyimide mask 204, copper pad 208, die past layer 206, silicon layer 210, and mold compound 212. However, any combination of packages (e.g. flip chip, CSP, PCB, etc.) may be modeled to reflect the device being evaluated.

As shown in FIG. 16, the simulated model 200 was analyzed with four-nodes, and axisymmetric elements, thus having a left border at the central axis 216 of the model. The right boarder was restrained with rollers, and a compressive stress wave 214 was applied at the bottom of the mold compound 212.

The maximum tensile stress in the joint 218 was then calculated. If the interferometerically-recorded velocity profile from the polished surface of the electronic substrate, taken as an input to the simulated model, is chosen to be the threshold laser energy at which the solder balls are separated from the joint, then the maximum tensile stress corresponds to the joint strength. FIGS. 17 and 18 show results of the simulation, with FIG. 17 showing the peak interfacial stress over time, and FIG. 18 showing the peak interfacial stress and varying laser energies.

The above method may be configured such that the critical laser energy for solder ball spallation is recorded and converted into a joint strength value using a simple computer program, without the need for any interferometeric measurements. Thus, the simulated model 200 of FIG. 16 takes the data obtained from the setup of FIG. 15 and uses a computerized chart to convert the laser energy into a joint strength value.

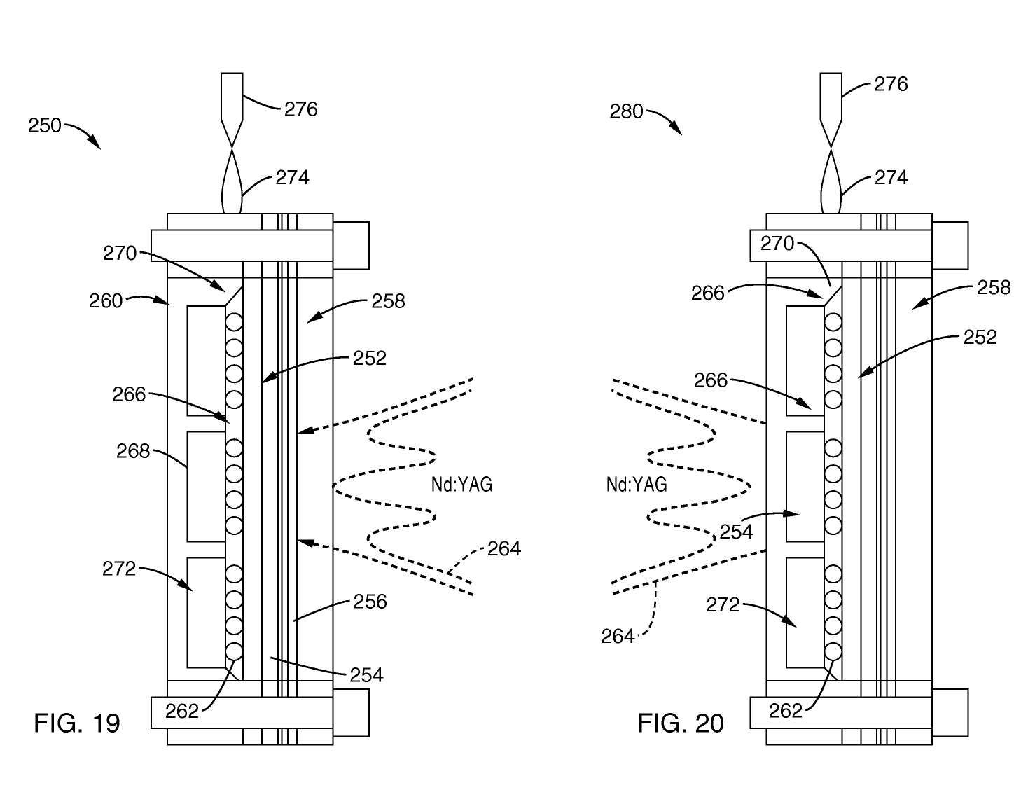

Referring now to FIG. 19, a further test sample 250 allows measuring the tensile strengths of embedded solder joints in-situ. Accordingly, unlike the embodiments shown in FIGS. 6-18, there is no need to polish off the board, die or the plastic substrate to expose the joint to be tested, as testing can be accomplished in-situ with the board or the plastic substrate and the die sandwiching the two joints.

The back surface 252 of device 260 (e.g. of the plastic substrate in a flip chip package or a PCB board in the CSP package) is shot with a YAG laser pulse 264 over a certain area. As in previous embodiments, there may be a need in some packages to put the laser absorbing metal film 254 on top of the free surface 252 of the plastic substrate/board and a confining waterglass layer 256 to further enhance the amplitude of the laser-generated stress wave. An epoxy glass sample holder 258 may also be used to hold the elements together as an assembly.

The compressive stress wave generated by the laser 264 travels through the plastic substrate (the PCB board in a CSP package), enters the solder ball region or joint 270 (occupied by liquid underfill 266 and solder balls 262), and then propagates through to the other side into the silicon die or CSP 272. The transmitted compression wave travels through the silicon die 262 and then reflects into a tensile wave from its free surface 266. The returning tensile wave then loads the solder region 270 in tension and leads to the failure of the joint at a critical laser energy.

In the case of a flip chip package, the solder balls 262 are surrounded by the underfill material 266. The presence of the underfill material 266 then provides a continuous pathway for the stress wave that is generated in the plastic substrate 252 to pass through the joint 270 to the other side into the silicon die 272.

However, in cases, such as for example, a CSP package, where the die is directly soldered to the substrate or the board, there is no underfill that surrounds the solder balls (e.g. see solder balls 118 of FIGS. 4 and 5). Since air that surrounds the solder balls in such cases is not a good transmitter of the stress wave, the compression wave that is generated by the laser in the board or the substrate cannot pass through the joint region 270 on the other side in the Si die. Because of this, no tensile stress wave is generated and therefore the solder joints cannot be pulled apart. To address such cases, the area around the solder balls is filled with a liquid medium 274 (e.g. water or oil deposited via dropper 276), which then provides the propagation medium for the laser generated compression stress wave. The transmitted compression stress wave then reflects into a tensile wave from the free surface of the CSP package 272 (Si die) and loads the joint 270 in tension and leads to their failure at a critical laser energy. Thus, use of a liquid layer is substantially equivalent to the underfill material 270 in the flip chip case.

The die may also be cut into smaller (e.g., 2 to 4 mm×2 to 4 mm) size islands using a slow diamond saw. The cuts on all four sides separating the islands are made all the way down to the package/board interface. Thus, each island is isolated from its neighbor. This island geometry allows taking more shots from a single specimen and also makes the testing over a narrow region possible, such that any spatial variation in the joint strength can be readily measured.

Referring now to FIG. 20, the above experiments can also be performed with test setup 280 by focusing the laser 264 on the silicon die surface or the CSP package surface 272, in which case the stress wave directions are revered, i.e. the compression wave that is generated in the silicon die 272 transmits through the joint region 270 and is reflected back into a tensile wave from the free surface of the plastic substrate (or PCB) 252. The returning tensile wave then fails the desired solder joint 270.

In either setup 250 (FIG. 19) or 280 (FIG. 20), the experiment could be used to test solder joints in terms of critical laser energies only, without quantifying the amplitude of the stress wave that eventually accomplishes the joint failure. Even without knowing the actual stress, the laser energies can be used as a relative measure of the joint strength when comparing different thermal aging conditions, or different metal pads.

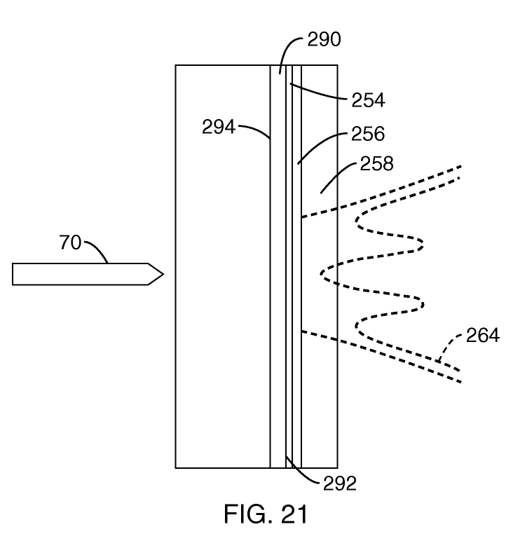

In a further embodiment, the qualitative process used for test setups 250 (FIG. 19) or 280 (FIG. 20) is made quantitative by calculating the tensile strength of the solder joint by using interferometry and a wave mechanics-based simulation. As shown in FIG. 21, the stress wave generated in the electronic substrate 290 (whether the die or the PCB or the plastic substrate) is measured in a separate experiment. In this case, the substrate 290 is tested without being attached to its counterpart. For example, a stress wave to be generated inside a plastic substrate or a PCB (as detailed in FIG. 19 and the associated text) is achieved without completing the task of attaching it to the silicon die or the CSP package 272. Alternatively, if the stress wave is to be generated inside the die (as detailed in FIG. 20 and the associated text), then it is obtained without attaching it to the PCB or the plastic substrate.

The substrate 290 may either be commercially available, or may be polished off its counterpart from completely assembled PCB/die, or die/substrate, etc., structures. Once such a substrate is obtained, the backside 292 of it is configured similar to the setups of FIGS. 19 and 20. For example, a layer of metal 254 and the accompanying waterglass 256 is provided if necessary. The same laser energy 264 and laser focus area used in FIG. 19 or 20 to completely separate the solder ball at the joint is then directed at bottom surface 292 to generate the stress wave in the electronic substrate 290. This stress wave propagates away from the laser impingement area and travels through the substrate thickness to reach the second free surface 294 of the substrate that was created by polishing off its counterpart (if present). An optical interferometer 70 is then directed at surface 294 to determine the stress wave profile generated in this electronic substrate 290 by recording its free surface velocity induced by the reflecting stress wave.

Finally, this experimentally measured stress wave profile in the electronic substrate 290 is used as an input to a wave propagation model (e.g. one similar to that shown in FIG. 16) that models the interaction of the stress wave with the entire package geometry, inclusive of its counterpart (die, plastic substrate or the CSP package, as the case may be). The maximum tensile stress in the joint is calculated. This corresponds to the joint strength if the interferometerically recorded velocity profile from the polished surface of the electronic substrate corresponded to the threshold laser energy at which the solder balls were separated from the joint.

The above method may be configured such that the critical laser energy for solder ball spallation is recorded and converted into a joint strength value using a simple computer program, without the need for any interferometeric measurements. Thus, the data from the setup of FIG. 21 may be input into the simulated model and a computerized chart to convert the laser energy into a joint strength value

Note that in all of the above embodiments, any other pulsed laser can also be used to generate the interrogating stress wave which eventually separates the desired solder joint.

Similarly, the above procedure could be used to test the strength of any non-electronic joint in which the die 272 is a tile of any material (e.g., composite, metal, plastic) that is joined via mechanical and/or chemical means (e.g., epoxies, screws, and other joint materials) to form a joint 270/262 with another underlying material 252. The aforesaid procedure can then be used to test the joint strength or could be used as a proof test when the laser energy is kept below the critical value. However, to fix the proof test laser energy level, one will still need to find the critical laser energy at which the joint separates.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Laser Energy Used to Spall the Solder Balls

| Number of | Laser Energy |
|---|---|
| Shot | (mJ) |
| 1F | 41.6 |
| 2F | 26.0 |
| 3F | 28.3 |
| 4F | 24.4 |
| 5F | 25.7 |
| 6F | 26.7 |
| 7F | 24.5 |
| 8F | 24.8 |
| 9F | 26.3 |
| 10F | 29.0 |
| 11F | 26.0 |
| 12F | 28.5 |
| 13F | 27.4 |
| 14F | 29.9 |
| 15F | 24.5 |
| 16F | 26.6 |
| 17F | 25.7 |
| 18F | 23.8 |
| 19F | 28.9 |
| 20F | 26.7 |

What is claimed is:

1. A method for measuring the tensile strength of a joint, the joint disposed between a joint material and an underlying structure, comprising:
directing a laser pulse at a first surface in communication with the joint; and
generating a stress wave in the joint as a result of the laser pulse;
wherein the stress wave propagates from the first surface to the joint to generate a tensile stress in the joint.

2. A method as recited in claim 1, wherein directing a laser pulse at a first surface comprises directing a Nd-Yag laser at the first surface.

3. A method as recited in claim 1, wherein the tensile stress is configured to separate the joint material from the underlying structure.

4. A method as recited in claim 3:
wherein the first surface comprises an exposed surface of the joint material; and
wherein the stress wave propagates through the joint material and into the joint.

5. A method as recited in claim 4:
wherein the joint material is coupled to the underlying structure via an intermediate pad; and
wherein the tensile stress separates the joint material from the intermediate pad.

6. A method as recited in claim 3, further comprising:
determining a critical laser energy sufficient to cause the joint material to separate from the underlying structure; and
calculating the strength of the joint as a function of the value of said critical laser energy.

7. A method as recited in claim 1, wherein the underlying structure comprises a single layer of material.

8. A method as recited in claim 1, wherein the underlying structure comprises multiple layers.

9. A method as recited in claim 8, wherein the multiple layers comprise die paste, silicon, and mold compound.

10. A method as recited in claim 8, wherein the multiple layers comprise plies of a composite material.

11. A method as recited in claim 8, wherein the multiple layers comprise layers of different composite materials.

12. A method as recited in claim 3, further comprising:
directing an interferometer at a second surface opposite said first surface; and
measuring the free velocity of the second surface.

13. A method as recited in claim 12, further comprising:
generating a stress wave profile from the measured free velocity.

14. A method as recited in claim 13, further comprising:
calculating the peak tensile stress amplitude at a location in the joint;
wherein the peak tensile stress corresponds to the strength of the joint.

15. A method as recited in claim 1, wherein the joint is formed using an adhesive material.

16. A method as recited in claim 1, wherein the joint is formed using mechanical means.

17. A method as recited in claim 1, wherein the joint is formed using a combination of mechanical means and chemical means.

18. A method as recited in claim 1, wherein the joint is formed using pressure across said joint material and underlying structure.

19. A method as recited in claim 15:
wherein the joint is disposed between a metal and an underlying structure comprising a composite material; and
wherein the laser pulse is configured to be directed to measure the tensile strength either between said metal and said adhesive material, or between the composite material and the adhesive material.

20. A method as recited in claim 15:
wherein the joint is disposed between a composite material and an underlying structure comprising a composite material; and
wherein the laser pulse is configured to be directed to measure the tensile strength either between either composite material and the adhesive material.

21. A method as recited in claim 3:
wherein the first surface comprises a free surface of the underlying structure; and
wherein the stress wave propagates through the underlying structure and into the joint.

22. A method as recited in claim 21, further comprising:
depositing a laser energy absorbing material adjacent the first surface;
wherein directing a laser pulse comprises directing a laser pulse at the laser energy absorbing material to generate the stress wave in the underlying structure.

23. A method as recited in claim 22, further comprising:
covering said laser energy absorbing material with a solid or liquid constraining material.

24. A method as recited in claim 19:
wherein the laser pulse is directed at a free surface of the underlying structure to measure the tensile strength of the joint in situ.

25. A method as recited in claim 19:
wherein the laser pulse is directed at a free surface of the metal to measure the tensile strength of the joint in situ.

26. A method as recited in claim 20, wherein the laser pulse is directed at a free surface of either composite material to measure the tensile strength of the joint in situ.

27. An apparatus for measuring the tensile strength of a joint, the joint disposed between a joint material and an underlying structure, comprising:
a laser source configured to be directed at a first surface in communication with the joint;
said laser source configured to generate a stress wave in the joint;
wherein the stress wave propagates from the first surface to the joint to generate a tensile stress in the joint.

28. An apparatus as recited in claim 27, wherein the laser source comprises a Nd-Yag laser.

29. An apparatus as recited in claim 27, wherein the laser source is configured to separate the joint material from the underlying structure.

30. An apparatus as recited in claim 27, further comprising:
a processor configured to determine a critical laser energy sufficient to cause the joint material to separate from the underlying structure; and
said processor further configured to calculate the strength of the joint as a function of the value of said critical laser energy.

31. An apparatus as recited in claim 27, further comprising:
an interferometer configured to be directed at a second surface opposite said first surface;
wherein said interferometer is configured to measure the free velocity of the second surface.

32. An apparatus as recited in claim 31, further comprising:
a processor configured to generate a stress wave profile from the measured free velocity.

33. An apparatus as recited in claim 31:
wherein said processor is further configured to calculate the peak tensile stress amplitude at a location in the joint; and
wherein the peak tensile stress corresponds to the joint strength.

34. An apparatus as recited in claim 29:
wherein the first surface comprises an exposed surface of the joint material; and
wherein the laser source is configured to propagate the stress wave through the joint material and into the joint.

35. An apparatus as recited in claim 29:
wherein the first surface comprises a free surface of underlying structure; and
wherein the laser source is configured to propagate the stress wave through the underlying structure and into the joint.

36. An apparatus as recited in claim 35, further comprising:
a laser energy absorbing material located adjacent the first surface;
wherein the laser energy absorbing material is configured to expand upon impingement of a laser pulse from the laser source to generate the stress wave in the underlying structure.

37. A method for generating a stress wave in a joint, the joint disposed between a joint material and an underlying structure, comprising:
directing a laser pulse at a first surface in communication with the joint;
generating a stress wave in the joint as a result of the laser pulse; and
propagating the stress wave from the first surface to the joint to generate a tensile stress in the joint.

38. A method as recited in claim 37, further comprising:
separating the joint material from the underlying structure.

39. A method as recited in claim 38:
wherein directing a laser pulse at a first surface comprises directing a laser pulse an exposed surface of the joint material; and
propagating the stress wave through the joint material and into the joint to separate the joint material from the underlying structure.

40. A method as recited in claim 38, further comprising:
determining a critical laser energy sufficient to cause the joint material to separate from the underlying structure; and
calculating the strength of the joint as a function of the value of said critical laser energy.

41. A method as recited in claim 38, further comprising:
directing an interferometer at a second surface opposite said first surface;
measuring the free velocity of the second surface;
generating a stress wave profile from the measured free velocity; and
calculating the peak tensile stress amplitude at a location in the joint;
wherein the peak tensile stress corresponds to the strength of the joint.
